(19) United States
(12) Patent Application Publication
(10) Pub. No.: US 2024/0150188 A1
(43) Pub. Date: May 9, 2024

(54) PRODUCTION OF RENEWABLE AMMONIA

(71) Applicant: REMO ENERGY, INC., Boston, MA (US)

(72) Inventor: Guido RADAELLI, Pleasant Hill, CA (US)

(21) Appl. No.: 18/264,920

(22) PCT Filed: Feb. 9, 2022
(86) PCT No.: PCT/US2022/015764

§ 371 Date: Aug. 9, 2023

Related U.S. Application Data
(60) Provisional application No. 63/147,947, filed on Feb. 10, 2021.

(51) Int. Cl. C01C 1/04; B01D 53/00; B01D 53/047; B01D 53/14; B01D 53/22; B01D 53/26; B01D 53/28; C25B 1/04; C25B 15/08

(52) U.S. Cl. CPC C01C 1/0464; B01D 53/002; B01D 53/0476; B01D 53/1493; B01D 53/22; B01D 53/261; B01D 53/263; B01D 53/28; C01C 1/0417; C01C 1/047; C25B 1/04; C25B 15/081; B01D 2252/102; B01D 2252/103; B01D 2257/102; B01D 2257/108; B01D 2257/80; B01D 2259/4009

(57) ABSTRACT

A renewable ammonia synthesis process is provided.

### BACKGROUND

### Technical Field

The commercial manufacturing of ammonia and nitrogen derivatives—mostly used as synthetic fertilizers in agriculture—is a major contributor to global GHG emissions. It is estimated that approximately 3-5% of global carbon dioxide emissions are in fact generated in the production of ammonia and its derivatives.

It is becoming increasingly evident that any effective industrial decarbonization strategy must include the reduction of GHG emissions in this field. The most common approach consists of the replacement of the hydrocarbon reforming step conventionally used in ammonia production with water electrolysis hydrogen production, powered by renewable energy. While technically viable, this approach is not commercially deployed because the resulting process does not match the requirements imposed by the renewable energy infrastructure and availability, such as its distributed nature and its intrinsic supply fluctuations (as opposed to the centralized nature of conventional ammonia production and the continuous and reliable supply of natural gas as a feedstock).

The present disclosure describes a novel integrated process based on electrolytic hydrogen that is designed to match these intrinsic requirements, specifically scalability and simplicity dictated by distributed applications and operating flexibility to match the inherent discontinuous renewable power supply.

### Description of the Related Art

The production of synthetic ammonia and its derivatives has been one of the key enablers of the global development of intensive agriculture. It is estimated that, without synthetic nitrogen fertilizers, the world would require three to four times more arable land to sustain current food production requirements.

The commercial production of synthetic ammonia was enabled by the discovery of iron-based catalysts capable of reacting hydrogen with nitrogen at industrially viable conditions, usually at pressures of few hundred atmospheres and temperatures above 400° C. In this traditional process the hydrogen feed is generated via steam reforming of hydrocarbons, natural gas being the most common hydrocarbon utilized. The nitrogen is introduced into the process in the form of air and the oxygen is combusted with a fraction of the hydrocarbons to generate part of the heat required by steam reforming.

The above described basic process architecture has not changed in any significant way since the first commercial production of synthetic ammonia many decades ago. Over the years the technology development has proceeded in two main directions:
i) a continuous optimization to achieve an incrementally improved utilization of the energy contained in the hydrocarbon feed via more and more sophisticated heat and mass integration; and
ii) a continuous scale-up effort to increase the maximum single train size to the current world scale capacities above 3,500 metric tons per day (MTD).

The commercial manufacturing processes that have resulted from these two development strategies cannot be easily adapted and deployed for the production of renewable ammonia, especially if the hydrogen feed is generated via water electrolysis powered with renewable energy. In fact, ammonia production from renewable power does not include a hydrocarbon feed and is typically very distributed in nature.

### BRIEF SUMMARY

The new process described in this application uniquely combines and adapts several process elements which have been developed for other purposes—such as the recovery of the ammonia product via water absorption, originally developed for the integrated production of ammonia and urea—and uniquely enables an entirely new integrated sequence of unit operations based on the optimal fit with electrolytic hydrogen generation and manufacturing of ammonia products directly usable by final users, such as aqueous ammonia solutions.

### BRIEF DESCRIPTION OF THE DRAWINGS

FIG. 1 shows the process with ammonia wash.

FIG. 2 shows the process with a dehydration unit.

### DETAILED DESCRIPTION

### Process Description

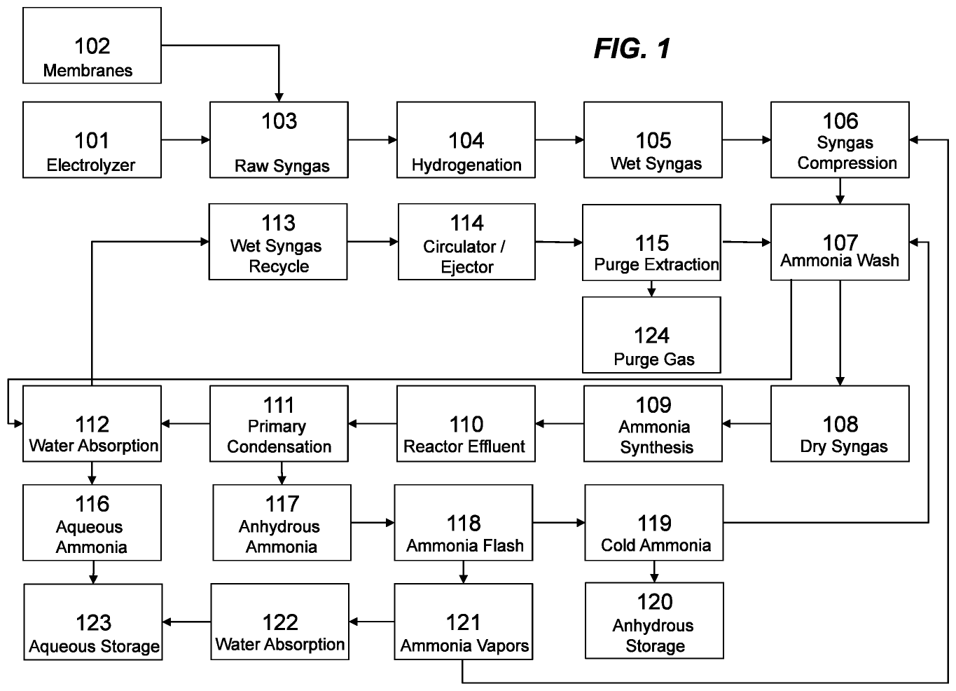

With reference to FIG. 1, the novel process is comprised of the steps described here below.

The hydrogen required for the ammonia synthesis is provided by the electrolyzer 101, which utilizes electric power to convert water into hydrogen and oxygen. The ammonia product is considered renewable if a portion of the power fed to the electrolyzer originated entirely or partly from a renewable source or if such power is sourced from the grid or any other source in combination with the acquisition of renewable power credits or similar financial instruments. For this process, the electrolyzer 101 does not require a hydrogen purification unit to remove oxygen impurities, as the final oxygen removal is performed in the hydrogenation reactor 104. However, in other embodiments a hydrogen purification unit may be beneficial.

The nitrogen required for the ammonia synthesis is generated from the separation of nitrogen from air or from the enrichment of nitrogen in air. For example, such enrichment can be obtained via the use of the membranes 102, which would produce a stream with nitrogen in excess of 80% mol. Alternatively, a PSA or VPSA can also be utilized to produce a nitrogen rich stream with a nitrogen concentration in excess of 80% mol. Alternatively, an Air Separation Unit (ASU) can also be utilized to separate nitrogen from air via air liquefaction and/or distillation. Any other means of separating nitrogen from air or enriching nitrogen in air can be utilized for this process as long as the nitrogen concentration in the resulting stream is above 80% mol.

The hydrogen and nitrogen streams are mixed together to produce the raw syngas stream 103, which contains oxygen in addition to hydrogen, nitrogen and other minor impurities. The raw syngas is pre-heated to the inlet temperature required by the hydrogenation reactor 104, usually a temperature between ambient and 300° C. depending on the exact type and composition of the hydrogenation catalyst utilized. The pre-heating can be performed either with an external source of energy (for example, an electric heater) or by recovering heat from an appropriate stream within the process via heat exchange (for example, by exchanging heat between the hydrogenation reactor 104 effluent and its feed stream) or with any combination thereof.

The hydrogenation reactor 104 is a fixed bed reactor that employs a standard hydrogenation catalyst, such as the ones utilized for hydrogen purification from electrolytic cells. For example, a catalyst containing platinum or palladium is conventionally utilized for these applications. The design of the hydrogenation reactor 104 can be single-stage adiabatic, for example, a vessel containing one type of catalyst. Alternatively, it can be a multi-stage adiabatic reactor, for example, with multiple sections of catalyst (either the same catalyst or optionally different catalysts optimized for each section of the reactor), in series with heat exchangers in between each catalyst bed. It can also be an isothermal or pseudo-isothermal reactor, including any means of providing heat exchange inside the catalytic bed. In some embodiments the hydrogenation reactor 104 can also be a combination of such designs.

The effluent from the hydrogenation reactor 104 is the wet syngas stream 105, which contains hydrogen, nitrogen, minor impurities and the water generated by the combination of hydrogen and oxygen in the hydrogenation reactor 104. The wet syngas stream 105 is cooled to ambient temperature via heat exchange with other process streams, water cooling, air cooling, direct quench with water or even below ambient temperature by heat exchange with another cold fluid (such as ammonia or any ammonia containing stream), or any combination thereof.

The wet syngas stream 105 is then compressed to the ammonia synthesis pressure by the syngas compressor 106. The ammonia synthesis pressure will be between 100 and 400 atmospheres. In one embodiment the syngas compressor is a multi-stage reciprocating compressor driven by one or more electric motors or by one or more turbines. Interstage coolers and separators are included in the compressor unit as needed for the proper operation of the unit. Controls are provided to deliver the syngas at any pressure between the suction and the maximum operating pressure that the compressor is designed for. Specifically, the system is designed to operate only a portion of the compression stages if required by the optimal operation of the process.

In another preferred embodiment the wet syngas compressor 105 is a multi-stage centrifugal compressor driven by one or more electric motors or by one or more turbines. Interstage coolers and separators are included in the compressor unit as needed for the proper operation of the unit. Controls are provided to deliver the syngas at any pressure between the suction and the maximum operating pressure that the compressor is designed for. Specifically, the system is designed to operate only a portion of the compression stages if required by the optimal operation of the process.

The compressed syngas is delivered to the ammonia wash unit 107 where the wet compressed syngas is first mixed with the wet recycle syngas and then contacted with a cold ammonia stream to remove the water from the gas phase by creating a diluted ammonia aqueous solution. As any expert in ammonia process design would recognize, an ammonia wash system can be implemented in several ways. One such way would consist in injecting cold liquid ammonia into the wet syngas stream via an online mixer. Another such way would consist in contacting the cold ammonia with the wet syngas stream in a properly designed tower.

The diluted aqueous ammonia solution from the ammonia wash unit 107 is sent to water wash unit 112 where it is mixed with the aqueous ammonia product generated by washing the reactor effluent with water.

The dry syngas stream 108 can be fed to the ammonia synthesis reactor 109 without the risk of damaging or poisoning the ammonia contained in the ammonia synthesis reactor 109, which is sensitive to all oxygenated compounds. Several designs can be adopted for the ammonia synthesis reactor 109. In a preferred embodiment the ammonia synthesis reactor 109 is a multistage adiabatic reactor with multiple layers of catalyst separated by heat exchangers; the catalyst beds can be contained in separate vessels or in a single vessel and the heat exchangers can be external to said vessels or contained inside them. The catalytic beds can have an axial, axial-radial or radial design.

In another preferred embodiment the ammonia synthesis reactor 109 is a pseudo-isothermal reactor with one or more layers of catalyst that feature heat exchange elements inserted in the catalytic bed, such as tubes or plates. The catalyst beds can be contained in separate vessels or in a single vessel and can have an axial, axial-radial or radial design.

The ammonia synthesis reactor effluent 110 is cooled via heat exchange with another process stream or with an external stream, such as water or air, or any combination thereof. Additional cooling can be provided with direct injection of cold ammonia into the reactor effluent (direct quenching) or via an ammonia chiller (indirect cooling generated by ammonia evaporation with the vapors coming from ammonia wash unit 107 and sent to water wash unit 112).

Depending on the operating pressure and temperature of the primary condenser unit 111 of the ammonia synthesis, a portion—ranging between 0% and 80%—of the ammonia contained in the reactor effluent condenses and forms the liquid stream of anhydrous ammonia 117, which is separated from the syngas stream in the gas-liquid separator included in the primary condenser unit 111.

The pressure of the anhydrous ammonia 117 is reduced in one or more adiabatic expansions, usually performed with suitably designed valves and gas-liquid separators. In alternative embodiments the pressure reduction may take place in an expander or any combination of expander and adiabatic flashes. The final anhydrous ammonia product is stored at i) either ambient temperature and a pressure above the corresponding vapor pressure (usually 15-20 atmospheres), or ii) at ambient pressure under cryogenic conditions (−33° C.), or iii) any intermediate pressure between ambient and 15-20 atmospheres.

A portion ranging from 0% to 100% of the vapors generated by the adiabatic expansions are sent to unit 122 where said vapors are absorbed in water to create an aqueous solution that is mixed with the aqueous product from unit 116. The remaining portion is sent to the suction of the relevant stage of the syngas compressor 106 based on the pressure of said vapors and the suction of each individual stage.

The remaining ammonia contained in the syngas vapors from the primary condenser unit 111 is separated from the gas phase via absorption with water in water wash unit 112. This unit contains one or more layers of contacting material, such as random or structured packing, that provide the surface required for the intimate contact between the liquid and the gas phase. Since the dissolution of ammonia in water is exothermic, proper cooling is required to prevent the temperature in water wash unit 112 to exceed the maximum value of 50-70° C. Proper cooling can be provided by heat exchangers inserted between layers of contacting material, by coils inserted in said layers, by pump-arounds with or without heat exchangers, or by any combination thereof.

The water wash unit 112 is designed to produce an aqueous ammonia solution with an ammonia title below 25% w, preferably in the 16-20% w range. The ammonia concentration in the aqueous product must be below 25% to ensure complete ionization of ammonia in water and prevent the formation of any ammonia vapors from such solution. The aqueous ammonia stream from unit 116 is stored in unit 123, which can consist of simple open tanks or ponds due to the absence of ammonia in the vapor.

The only inputs in this process are air, water and electric power and the end products are aqueous and anhydrous ammonia, which can be generated in any combination depending on the design and operating parameters selected for the process.

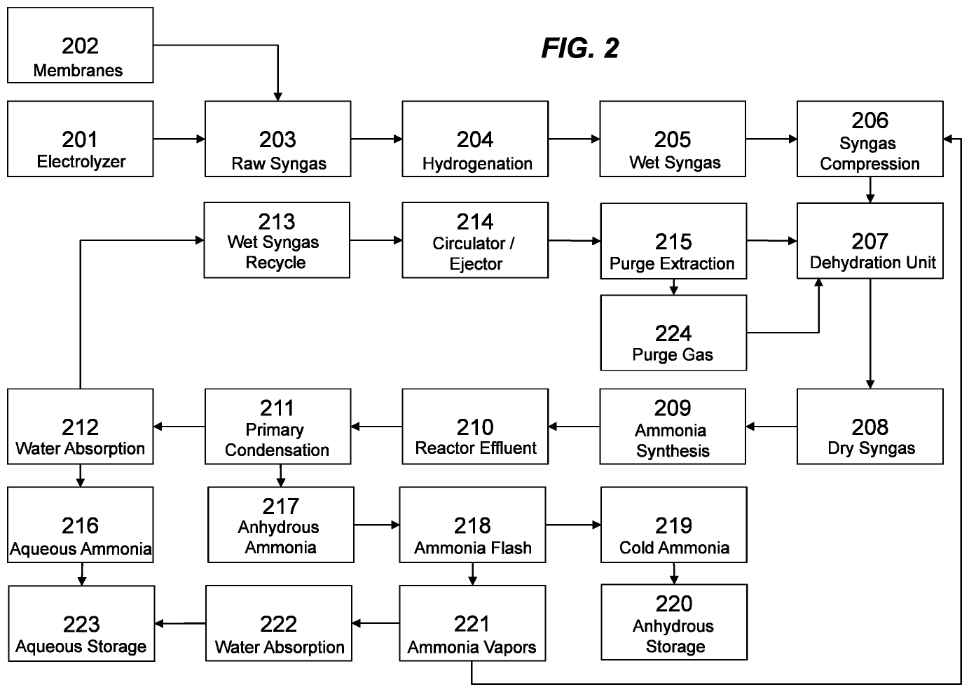

The embodiment represented in FIG. 2 represents the same process that utilizes a different method to remove water from the wet syngas in unit 207. In this case the syngas is dried in a dehydration unit, which is operated in a Temperature Swing Adsorption (TSA) cycle. Unit 207 consists of two or more vessels filled with sorbent material (such as molecular sieve) that has a high affinity to water. One or more vessels are operated in adsorption mode: the water in the wet syngas is adsorbed by the sorbent while the gas stream flows through the bed. Once the sorbent is saturated with water, the vessels are switched to the regeneration mode. While some vessels are operated in adsorption mode, the remaining are operated in regeneration mode: the purge gas stream 224 is heated to a suitable temperature (usually between 150 and 350° C.) and passed over the saturated sorbent material to evaporate the water contained in the sorbent. The location of the purge extraction unit 215 in the synthesis loop can vary depending on the specific design and operating conditions. For example, the purge can be extracted from the effluent downstream of the primary condenser 211 or from the dry syngas produced by the dehydration unit itself.

### Process Control and Optimization

Compared to a traditional ammonia manufacturing process, the above-described process presents the following unique features:
i) absence of very high temperature equipment such as the reforming furnaces and the connected steam systems;
ii) absence of very low temperature equipment such as the ammonia refrigeration cycle usually adopted to condense the anhydrous ammonia; and
iii) production of both aqueous and anhydrous ammonia in an adjustable and controllable ratio.

These features make the process an ideal match for the distributed production of green ammonia from renewable power, which is by nature distributed. First, distributed production requires integrating the process with the downstream portion of the ammonia value chain to offset the lack of economies of scale with the higher product prices available at the wholesale or retail steps (as opposed to plant gate). In the downstream portion of the value chain ammonia is usually supplied in two forms, aqueous and anhydrous.

Second, the inherent fluctuations in the availability of renewable power require any process based on such an input to be able to quickly adjust its load and re-optimize its operating parameters based on the available inputs and desired output. This cannot be achieved with a conventional world scale ammonia plant, which usually requires few hours to vary its production rate by as little as 5% and regain optimal steady state due to the thermal inertia and related mandated temperature ramps for large equipment that operates at extreme temperatures, such as the reforming furnaces and the refrigeration units.

In order to take advantage of the unique features presented above, the novel process here described is designed to operate with new Advanced Process Control (APC) algorithms customized to achieve the following targets:
i) rapid adjustment of the total production rate (5% load change in minutes);
ii) very wide operating window for production rate (20%-100%); and
iii) ability to produce any ratio of aqueous versus anhydrous product at the minimum possible energy consumption achievable for each ratio target.

This leads to two new algorithms. Algorithm 1:
Goal: match total ammonia production rate with available renewable power while minimizing changes to gas flows in the high pressure equipment (this maximizes the rate of change in production rate while maintaining acceptable pseudo-stationary conditions);
Step 1: Determine maximum hydrogen production rate based on the available renewable power;
Step 2: Compute the hydrogen/nitrogen ratio (H/N) required in the syngas to maintain the gas flows through the synthesis loop constant;
Step 3: Determine required nitrogen production rate; Step 4: Determine purge rate based on the excess nitrogen in the syngas;
Step 5: Set all new setpoints accordingly; and
Step 6: Adjust rotating speed and kickback flows of the syngas compressor to maintain constant pressure in the synthesis loop.

Algorithm 2:
Goal: achieve the desired ratio of aqueous and anhydrous ammonia production while minimizing energy consumption in any scenario;
Step 1: Calculate the desired production rates of anhydrous and aqueous ammonia;
Step 2: Increase the anhydrous production rate target by the amount corresponding to the evaporated ammonia in the adiabatic expansion;
Step 3: Calculate the operating pressure of the synthesis loop required to condense the desired amount of anhydrous ammonia in the primary condenser (calculated at step 2); and
Step 4: Use algorithm 1 to compute all set points at the desired total production rate (sum of aqueous and anhydrous) while maintaining the synthesis loop pressure calculated in step 3.

In one embodiment, a renewable ammonia synthesis process comprises the following steps: powering an electrolysis process comprising providing electricity generated by a renewable source; generating hydrogen via said electrolysis; compressing said hydrogen; generating a gas stream A comprising nitrogen and oxygen wherein the majority of gas stream A comprises nitrogen; mixing said hydrogen with gas stream A over a hydrogenation catalyst to hydrogenate at least some of the oxygenated species present in the mixed gas stream to form a new gas stream B; compressing gas stream B; mixing gas stream B with gas stream D below and removing water from said mixed gas stream; running said mixed and dried gas stream over an ammonia synthesis catalyst which is capable of reacting the hydrogen and nitrogen to form ammonia in one reactor vessel or more reactor vessels in parallel or in series; cooling the reacted gas below its dew point whereby to produce a liquid anhydrous ammonia stream and a stream C of reacted gas comprising hydrogen, nitrogen, ammonia and other minor impurities; separating the liquid anhydrous ammonia from the gas stream C to form a liquid ammonia stream E; contacting the gas stream C with water whereby to produce an aqueous solution of ammonia and a stream of unreacted gas comprising water vapor, hydrogen, nitrogen and other minor impurities (gas stream D); separating the resulting liquid comprising a mixture of ammonia and water from the remaining gas stream D; separating a portion of the gas stream D to create a purge gas stream F; and recycling gas stream D to mix it with stream B prior to removing the water.

In some embodiments gas stream A is generated using a Pressure Swing Adsorption (PSA) or Vacuum Pressure Swing Adsorption (VPSA) unit. In some embodiments gas stream A is generated using membranes. In some embodiments gas stream A is generated using an Air Separation Unit (ASU). In some embodiments the hydrogenation catalyst resides in a vessel. In some embodiments the hydrogenation catalyst resides in multiple vessels in series or in parallel. In some embodiments the hydrogenation catalyst is heated to between 150° C. and 300° C. In some embodiments the hydrogenation catalyst is cooled with heat exchange elements inserted in the catalyst. In some embodiments the hydrogenated gas leaving one hydrogenation catalyst bed is cooled prior to passing over the next hydrogenation catalyst bed. In some embodiments the compression of gas stream B is performed with a reciprocating compressor. In some embodiments the driver of the reciprocating compressor is an electric motor. In some embodiments the driver of the reciprocating compressor is a turbine. In some embodiments the compression of gas stream B is performed with a screw compressor. In some embodiments the driver of the screw compressor is an electric motor. In some embodiments the driver of the screw compressor is a turbine. In some embodiments the compression of gas stream B is performed with a centrifugal compressor. In some embodiments the driver of the centrifugal compressor is an electric motor. In some embodiments the driver of the centrifugal compressor is a turbine. In some embodiments the drying of gas streams B and D is performed by contacting said gas streams with a stream of liquid ammonia. In some embodiments the stream of liquid ammonia is a portion of the anhydrous ammonia stream E. In some embodiments the stream of liquid ammonia is recovered after the expansion of stream E and the recompression of the liquids formed after the expansion. In some embodiments the drying of gas streams B and D is performed by passing said streams over a bed of water sorbent material. In some embodiments the saturated sorbent material is regenerated by heating the sorbent material above a temperature of 150° C. In some embodiments the saturated sorbent material is regenerated by heating a portion or all of the purge gas stream F above a temperature of 150° C. and passing said heated stream over the saturated sorbent material.

In some embodiments the ammonia synthesis catalyst is contained in one or more axial catalyst beds. In some embodiments the ammonia synthesis catalyst is contained in one or more axial-radial catalyst beds. In some embodiments the ammonia synthesis catalyst is contained in one or more radial catalyst beds. In some embodiments the ammonia synthesis catalyst is contained in any combination of axial, axial-radial or radial catalyst beds. In some embodiments the ammonia synthesis catalyst is contained in one or more adiabatic catalyst beds. In some embodiments the ammonia synthesis catalyst is contained in one or more catalyst beds and the reacting gas is cooled with heat exchange elements inserted in at least one of the catalyst beds. In some embodiments the reacting gas leaving one bed is cooled before entering the following bed. In some embodiments the cooling is performed with a heat exchanger. In some embodiments the cooling is performed by directly contacting the reacted gas stream leaving the bed with a colder gas stream containing any combination of hydrogen, nitrogen, ammonia and inert species.

In some embodiments the reacted gas leaving the ammonia synthesis catalyst is cooled and the recovered heat is used to heat another cold stream in the process. In some embodiments the reacted gas leaving the ammonia synthesis catalyst is cooled with cooling water in a heat exchanger. In some embodiments the reacted gas leaving the ammonia synthesis catalyst is cooled with air in a heat exchanger. In some embodiments the reacted gas after the heat recovery is further cooled with cooling water in a heat exchanger. In some embodiments the reacted gas after the heat recovery is further cooled with air in a heat exchanger. In some embodiments the reacted gas after the heat recovery is first cooled with air in a heat exchanger and then cooling water in a subsequent heat exchanger. In some embodiments gas stream C is contacted with water over a packed bed containing material that increases the heat and mass transfer between the gas stream and water. In some embodiments the packing material is contained in multiple beds arranged in series or in parallel. In some embodiments the liquid stream leaving a packed bed is cooled in a heat exchanger. In some embodiments a portion or all of the cooled liquid stream is pumped and recycled to the inlet of the packed bed. In some embodiments the liquid stream leaving a packed bed is cooled by directly contacting it with a colder liquid stream. In some embodiments a portion or all of the cooled liquid stream is pumped and recycled to the inlet of the packed bed. In some embodiments the recycling of gas stream D is performed with a single-stage compressor (circulator). In some embodiments the circulator is driven by one of the drivers used by the compressor that compresses stream B. In some embodiments the circulator is driven by a dedicated electric motor. In some embodiments the circulator is driven by a dedicated turbine. In some embodiments the recycling of gas stream D is performed by properly contacting stream B with stream D in an ejector.

In one embodiment, the disclosure comprises a renewable ammonia synthesis process which comprises the following steps: powering an electrolysis process comprising providing electricity generated by a renewable source; generating hydrogen via said electrolysis; compressing said hydrogen; generating a gas stream A comprising nitrogen and oxygen wherein the majority of gas stream A comprises nitrogen; mixing said hydrogen with gas stream A over a hydrogenation catalyst to hydrogenate at least some of the oxygenated species present in the mixed gas stream to form a new gas stream B; compressing gas stream B; mixing gas stream B with gas stream D below and contacting said mixed gas stream with a stream of liquid ammonia whereby producing an aqueous solution of ammonia and a gas stream C containing hydrogen, nitrogen, ammonia and other minor impurities; running gas stream C over an ammonia synthesis catalyst which is capable of reacting the hydrogen and nitrogen to form ammonia in one reactor vessel or more reactor vessels in parallel or in series; cooling the reacted gas below its dew point whereby to produce a liquid anhydrous ammonia stream and a stream D of reacted gas comprising hydrogen, nitrogen, ammonia and other minor impurities; separating the liquid anhydrous ammonia from the gas stream D to form a liquid ammonia stream E; separating a portion of the gas stream D to create a purge gas stream F; and recycling gas stream D to mix it with stream B prior to contacting the gas mixture with liquid ammonia. In some embodiments gas stream A is generated using a Pressure Swing Adsorption (PSA) or Vacuum Pressure Swing Adsorption (VPSA) unit. In some embodiments gas stream A is generated using membranes. In some embodiments gas stream A is generated using an Air Separation Unit (ASU). In some embodiments the hydrogenation catalyst resides in a vessel. In some embodiments the hydrogenation catalyst resides in multiple vessels in series or in parallel. In some embodiments the hydrogenation catalyst is heated to between 150° C. and 300° C. In some embodiments the hydrogenation catalyst is cooled with heat exchange elements inserted in the catalyst. In some embodiments the hydrogenated gas leaving one hydrogenation catalyst bed is cooled prior to passing over the next hydrogenation catalyst bed. In some embodiments the compression of gas stream B is performed with a reciprocating compressor. In some embodiments the driver of the reciprocating compressor is an electric motor. In some embodiments the driver of the reciprocating compressor is a turbine. In some embodiments the compression of gas stream B is performed with a screw compressor. In some embodiments the driver of the screw compressor is an electric motor. In some embodiments the driver of the screw compressor is a turbine. In some embodiments the compression of gas stream B is performed with a centrifugal compressor. In some embodiments the driver of the centrifugal compressor is an electric motor. In some embodiments the driver of the centrifugal compressor is a turbine. In some embodiments the gas streams B and D are contacted with a portion of the anhydrous ammonia stream E. In some embodiments the gas streams B and D are contacted with a stream of liquid ammonia recovered after the expansion of stream E and the recompression of the liquids formed after said expansion. In some embodiments the ammonia synthesis catalyst is contained in one or more axial catalyst beds. In some embodiments the ammonia synthesis catalyst is contained in one or more axial-radial catalyst beds. In some embodiments the ammonia synthesis catalyst is contained in one or more radial catalyst beds. In some embodiments the ammonia synthesis catalyst is contained in any combination of axial, axial-radial or radial catalyst beds. In some embodiments the ammonia synthesis catalyst is contained in one or more adiabatic catalyst beds. In some embodiments the ammonia synthesis catalyst is contained in one or more catalyst beds and the reacting gas is cooled with heat exchange elements inserted in at least one of the catalyst beds. In some embodiments the reacting gas leaving one bed is cooled before entering the following bed. In some embodiments the cooling is performed with a heat exchanger. In some embodiments the cooling is performed by directly contacting the reacted gas stream leaving the bed with a colder gas stream containing any combination of hydrogen, nitrogen, ammonia and inert species. In some embodiments the reacted gas leaving the ammonia synthesis catalyst is cooled and the recovered heat is used to heat another cold stream in the process. In some embodiments the reacted gas leaving the ammonia synthesis catalyst is cooled with cooling water in a heat exchanger. In some embodiments the reacted gas leaving the ammonia synthesis catalyst is cooled with air in a heat exchanger. In some embodiments the reacted gas after the heat recovery is further cooled with cooling water in a heat exchanger. In some embodiments the reacted gas after the heat recovery is further cooled with air in a heat exchanger. In some embodiments the reacted gas after the heat recovery is first cooled with air in a heat exchanger and then cooling water in a subsequent heat exchanger. In some embodiments gas stream D is further cooled to a temperature below ambient temperature whereby generating another stream of liquid ammonia and a gas stream that contains less ammonia than gas stream D. In some embodiments the additional liquid ammonia stream is separated from the gas stream D. In some embodiments the recycling of gas stream D is performed with a single-stage compressor (circulator). The circulator is driven by one of the drivers used by the compressor that compresses stream B. In some embodiments the circulator is driven by a dedicated electric motor. In some embodiments the circulator is driven by a dedicated turbine. In some embodiments the recycling of gas stream D is performed by properly contacting stream B with stream D in an ejector.

In one embodiment, the disclosure comprises a renewable ammonia synthesis process which comprises the following steps: powering an electrolysis process comprising providing electricity generated by a renewable source; generating hydrogen via said electrolysis; compressing said hydrogen; generating a gas stream A comprising nitrogen and oxygen wherein the majority of gas stream A comprises nitrogen; mixing said hydrogen with gas stream A over a hydrogenation catalyst to hydrogenate at least some of the oxygenated species present in the mixed gas stream to form a new gas stream B; compressing gas stream B; mixing gas stream B with gas stream D below and removing water from said mixed gas stream; running said mixed and dried gas stream over an ammonia synthesis catalyst which is capable of reacting the hydrogen and nitrogen to form ammonia in one reactor vessel or more reactor vessels in parallel or in series; cooling the reacted gas above its dew point whereby to produce a stream C of reacted gas comprising hydrogen, nitrogen, ammonia and other minor impurities; contacting the gas stream C with water whereby to produce an aqueous solution of ammonia and a stream of unreacted gas comprising water vapor, hydrogen, nitrogen and other minor impurities (gas stream D); separating the resulting liquid comprising a mixture of ammonia and water from the remaining gas stream D; separating a portion of the gas stream D to create a purge gas stream F; recycling gas stream D to mix it with stream B prior to removing the water. In some embodiments gas stream A is generated using a Pressure Swing Adsorption (PSA) or Vacuum Pressure Swing Adsorption (VPSA) unit. In some embodiments gas stream A is generated using membranes. In some embodiments gas stream A is generated using an Air Separation Unit (ASU). In some embodiments the hydrogenation catalyst resides in a vessel. In some embodiments the hydrogenation catalyst resides in multiple vessels in series or in parallel. In some embodiments the hydrogenation catalyst is heated to between 150° C. and 300° C. In some embodiments the hydrogenation catalyst is cooled with heat exchange elements inserted in the catalyst. In some embodiments the hydrogenated gas leaving one hydrogenation catalyst bed is cooled prior to passing over the next hydrogenation catalyst bed. In some embodiments the compression of gas stream B is performed with a reciprocating compressor. In some embodiments the driver of the reciprocating compressor is an electric motor. In some embodiments the driver of the reciprocating compressor is a turbine. In some embodiments the compression of gas stream B is performed with a screw compressor. In some embodiments the driver of the screw compressor is an electric motor. In some embodiments the driver of the screw compressor is a turbine. In some embodiments the compression of gas stream B is performed with a centrifugal compressor. In some embodiments the driver of the centrifugal compressor is an electric motor. In some embodiments the driver of the centrifugal compressor is a turbine. In some embodiments drying of gas streams B and D is performed by contacting said gas streams with a stream of liquid ammonia. In some embodiments drying of gas streams B and D is performed by contacting said gas streams with a stream of a concentrated ammonia solution. In some embodiments drying of gas streams B and D is performed by passing said streams over a bed of water sorbent material. In some embodiments the saturated sorbent material is regenerated by heating the sorbent material above a temperature of 150° C. In some embodiments the saturated sorbent material is regenerated by heating a portion or all of the purge gas stream F above a temperature of 150° C. and passing said heated stream over the saturated sorbent material. In some embodiments the ammonia synthesis catalyst is contained in one or more axial catalyst beds. In some embodiments the ammonia synthesis catalyst is contained in one or more axial-radial catalyst beds. In some embodiments the ammonia synthesis catalyst is contained in one or more radial catalyst beds. In some embodiments the ammonia synthesis catalyst is contained in any combination of axial, axial-radial or radial catalyst beds. In some embodiments the ammonia synthesis catalyst is contained in one or more adiabatic catalyst beds. In some embodiments the ammonia synthesis catalyst is contained in one or more catalyst beds and the reacting gas is cooled with heat exchange elements inserted in at least one of the catalyst beds. In some embodiments the reacting gas leaving one bed is cooled before entering the following bed. In some embodiments the cooling is performed with a heat exchanger. In some embodiments the cooling is performed by directly contacting the reacted gas stream leaving the bed with a colder gas stream containing any combination of hydrogen, nitrogen, ammonia and inert species. In some embodiments the reacted gas leaving the ammonia synthesis catalyst is cooled and the recovered heat is used to heat another cold stream in the process. In some embodiments the reacted gas leaving the ammonia synthesis catalyst is cooled with cooling water in a heat exchanger. In some embodiments the reacted gas leaving the ammonia synthesis catalyst is cooled with air in a heat exchanger. In some embodiments the reacted gas after the heat recovery is further cooled with cooling water in a heat exchanger. In some embodiments the reacted gas after the heat recovery is further cooled with air in a heat exchanger. In some embodiments the reacted gas after the heat recovery is first cooled with air in a heat exchanger and then cooling water in a subsequent heat exchanger. In some embodiments gas stream C is contacted with water over a packed bed containing material that increases the heat and mass transfer between the gas stream and water. In some embodiments the packing material is contained in multiple beds arranged in series or in parallel. In some embodiments the liquid stream leaving a packed bed is cooled in a heat exchanger. In some embodiments a portion or all of the cooled liquid stream is pumped and recycled to the inlet of the packed bed. In some embodiments the liquid stream leaving a packed bed is cooled by directly contacting it with a colder liquid stream. In some embodiments a portion or all of the cooled liquid stream is pumped and recycled to the inlet of the packed bed. In some embodiments the recycling of gas stream D is performed with a single-stage compressor (circulator). In some embodiments the circulator is driven by one of the drivers used by the compressor that compresses stream B. In some embodiments the circulator is driven by a dedicated electric motor. In some embodiments the circulator is driven by a dedicated turbine. In some embodiments the recycling of gas stream D is performed by properly contacting stream B with stream D in an ejector.

In one embodiment, the disclosure comprises an operating algorithm comprising the following steps are applied to control the total ammonia production rate from any of the preceding processes: the total maximum ammonia production rate is determined based on the available electric power and the maximum hydrogen production rate achievable with said power; the hydrogen/nitrogen ratio (H/N) is computed in order to maintain the flowrate of gas stream C constant; the flowrate of gas stream A is computed based on the H/N computed in the previous step; the flowrate of purge gas stream F is computed based on the excess nitrogen present in stream B and compared to the stoichiometric value of 3 for H/N; and all new setpoints are set accordingly to all previous steps; the rotating speed and the kickback flows of the compressor of gas stream B are adjusted to maintain a constant pressure at its delivery. In some embodiments such algorithm is applied to any of the preceding processes.

In some embodiments the operating algorithm is applied to the preceding process comprising the following steps to control the ratio of the flowrate of liquid ammonia stream E and the total aqueous ammonia flowrate produced in said process: the desired flowrates of anhydrous (stream E) and aqueous ammonia are computed; the stream E flowrate target is increased by the amount corresponding to the evaporated ammonia in any subsequent adiabatic expansion; the pressure of gas stream B delivered by the compressor is calculated in order to generate the required amount of ammonia condensation once gas stream C is cooled; and the algorithm is used to compute all set points at the desired total ammonia production rate (sum of aqueous and anhydrous) while maintaining the pressure of gas stream B delivered by the compressor as computed in the previous step. In some embodiments such algorithm is applied to one of the preceding processes.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

U.S. Provisional Application 63/147,947, filed Feb. 10, 2021 is incorporated herein by reference, in its entirety.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A renewable ammonia synthesis process which comprises the following steps:
powering an electrolysis process comprising providing electricity generated by a renewable source;
generating hydrogen via the electrolysis;
compressing the hydrogen;
generating a gas stream A comprising nitrogen and oxygen wherein the majority of gas stream A comprises nitrogen;
mixing the hydrogen with gas stream A over a hydrogenation catalyst to hydrogenate at least some of the oxygenated species present in the mixed gas stream to form a new gas stream B;
compressing gas stream B;
mixing gas stream B with gas stream D below and removing water from the mixed gas stream;
running the mixed and dried gas stream over an ammonia synthesis catalyst which is capable of reacting the hydrogen and nitrogen to form ammonia in one reactor vessel or more reactor vessels in parallel or in series;
cooling the reacted gas below its dew point whereby to produce a liquid anhydrous ammonia stream and a stream C of reacted gas comprising hydrogen, nitrogen, ammonia and other minor impurities;
separating the liquid anhydrous ammonia from the gas stream C to form a liquid ammonia stream E;
contacting the gas stream C with water whereby to produce an aqueous solution of ammonia and a stream of unreacted gas comprising water vapor, hydrogen, nitrogen and other minor impurities (gas stream D);
separating the resulting liquid comprising a mixture of ammonia and water from the remaining gas stream D;
separating a portion of the gas stream D to create a purge gas stream F; and
recycling gas stream D to mix it with stream B prior to removing the water.

2. The process of claim 1 wherein gas stream A is generated using a Pressure Swing Adsorption (PSA) or Vacuum Pressure Swing Adsorption (VPSA) unit.

3. The process of claim 1 wherein gas stream A is generated using membranes.

4. The process of claim 1 wherein gas stream A is generated using an Air Separation Unit (ASU).

5. The process of claim 1 wherein the hydrogenation catalyst resides in a vessel.

6. The process of claim 1 wherein the hydrogenation catalyst resides in multiple vessels in series or in parallel.

7. The process of claim 1 wherein the hydrogenation catalyst is heated to between 150° C. and 300° C.

8. The process of claim 1 wherein the hydrogenation catalyst is cooled with heat exchange elements inserted in the catalyst.

9. The process of claim 1 wherein the hydrogenated gas leaving one hydrogenation catalyst bed is cooled prior to passing over the next hydrogenation catalyst bed.

10. The process of claim 1 wherein the compression of gas stream B is performed with a reciprocating compressor.

11. The process of claim 10 wherein a driver of the reciprocating compressor is an electric motor.

12. The process of claim 10 wherein the driver of the reciprocating compressor is a turbine.

13. The process of claim 1 wherein the compression of gas stream B is performed with a screw compressor.

14. The process of claim 13 wherein the driver of the screw compressor is an electric motor.

15. The process of claim 13 wherein the driver of the screw compressor is a turbine.

16. The process of claim 1 wherein the compression of gas stream B is performed with a centrifugal compressor.

17. The process of claim 16 wherein the driver of the centrifugal compressor is an electric motor.

18. The process of claim 16 wherein the driver of the centrifugal compressor is a turbine.

19. The process of claim 1 wherein drying of gas streams B and D is performed by contacting the gas streams with a stream of liquid ammonia.

20. The process of claim 19 wherein the stream of liquid ammonia is a portion of the anhydrous ammonia stream E.

21. The process of claim 19 wherein the stream of liquid ammonia is recovered after the expansion of stream E and the recompression of the liquids formed after the expansion.

22. The process of claim 1 wherein drying of gas streams B and D is performed by passing the streams over a bed of water sorbent material.

23. The process of claim 22 wherein the saturated sorbent material is regenerated by heating the sorbent material above a temperature of 150° C.

24. The process of claim 22 wherein the saturated sorbent material is regenerated by heating a portion or all of the purge gas stream F above a temperature of 150° C. and passing the heated stream over the saturated sorbent material.

25. The process of claim 1 wherein the ammonia synthesis catalyst is contained in one or more axial catalyst beds.

26. The process of claim 1 wherein the ammonia synthesis catalyst is contained in one or more axial-radial catalyst beds.

27. The process of claim 1 wherein the ammonia synthesis catalyst is contained in one or more radial catalyst beds.

28. The process of claim 1 wherein the ammonia synthesis catalyst is contained in any combination of axial, axial-radial or radial catalyst beds.

29. The process of claim 1 wherein the ammonia synthesis catalyst is contained in one or more adiabatic catalyst beds.

30. The process of claim 1 wherein the ammonia synthesis catalyst is contained in one or more catalyst beds and the reacting gas is cooled with heat exchange elements inserted in at least one of the catalyst beds.

31. The process of claim 29 wherein the reacting gas leaving one bed is cooled before entering the following bed.

32. The process of claim 31 wherein the cooling is performed with a heat exchanger.

33. The process of claim 31 wherein the cooling is performed by directly contacting the reacted gas stream leaving the bed with a colder gas stream containing any combination of hydrogen, nitrogen, ammonia and inert species.

34. The process of claim 1 wherein the reacted gas leaving the ammonia synthesis catalyst is cooled and the recovered heat is used to heat another cold stream in the process.

35. The process of claim 1 wherein the reacted gas leaving the ammonia synthesis catalyst is cooled with cooling water in a heat exchanger.

36. The process of claim 1 wherein the reacted gas leaving the ammonia synthesis catalyst is cooled with air in a heat exchanger.

37. The process of claim 34 wherein the reacted gas after the heat recovery is further cooled with cooling water in a heat exchanger.

38. The process of claim 34 wherein the reacted gas after the heat recovery is further cooled with air in a heat exchanger.

39. The process of claim 34 wherein the reacted gas after the heat recovery is first cooled with air in a heat exchanger and then cooling water in a subsequent heat exchanger.

40. The process of claim 1 wherein gas stream C is contacted with water over a packed bed containing material that increases the heat and mass transfer between the gas stream and water.

41. The process of claim 40 wherein the packing material is contained in multiple beds arranged in series or in parallel.

42. The process of claim 41 wherein the liquid stream leaving a packed bed is cooled in a heat exchanger.

43. The process of claim 42 wherein a portion or all of the cooled liquid stream is pumped and recycled to the inlet of the packed bed.

44. The process of claim 41 the liquid stream leaving a packed bed is cooled by directly contacting it with a colder liquid stream.

45. The process of claim 44 wherein a portion or all of the cooled liquid stream is pumped and recycled to the inlet of the packed bed.

46. The process of claim 1 wherein the recycling of gas stream D is performed with a single-stage compressor (circulator).

47. The process of claim 46 wherein a circulator is driven by one of the drivers used by the compressor that compresses stream B.

48. The process of claim 46 wherein the circulator is driven by a dedicated electric motor.

49. The process of claim 46 wherein the circulator is driven by a dedicated turbine.

50. The process of claim 1 wherein the recycling of gas stream D is performed by properly contacting stream B with stream D in an ejector.

51. A renewable ammonia synthesis process which comprises the following steps:
powering an electrolysis process comprising providing electricity generated by a renewable source;
generating hydrogen via the electrolysis;
compressing the hydrogen;
generating a gas stream A comprising nitrogen and oxygen wherein the majority of gas stream A comprises nitrogen;
mixing the hydrogen with gas stream A over a hydrogenation catalyst to hydrogenate at least some of the oxygenated species present in the mixed gas stream to form a new gas stream B;
compressing gas stream B;
mixing gas stream B with gas stream D below and contacting the mixed gas stream with a stream of liquid ammonia whereby producing an aqueous solution of ammonia and a gas stream C containing hydrogen, nitrogen, ammonia and other minor impurities;
running gas stream C over an ammonia synthesis catalyst which is capable of reacting the hydrogen and nitrogen to form ammonia in one reactor vessel or more reactor vessels in parallel or in series;
cooling the reacted gas below its dew point whereby to produce a liquid anhydrous ammonia stream and a stream D of reacted gas comprising hydrogen, nitrogen, ammonia and other minor impurities;
separating the liquid anhydrous ammonia from the gas stream D to form a liquid ammonia stream E;
separating a portion of the gas stream D to create a purge gas stream F; and
recycling gas stream D to mix it with stream B prior to contacting the gas mixture with liquid ammonia.

52. The process of claim 51 wherein gas stream A is generated using a Pressure Swing Adsorption (PSA) or Vacuum Pressure Swing Adsorption (VPSA) unit.

53. The process of claim 51 wherein gas stream A is generated using membranes.

54. The process of claim 51 wherein gas stream A is generated using an Air Separation Unit (ASU).

55. The process of claim 51 wherein the hydrogenation catalyst resides in a vessel.

56. The process of claim 51 wherein the hydrogenation catalyst resides in multiple vessels in series or in parallel.

57. The process of claim 51 wherein the hydrogenation catalyst is heated to between 150° C. and 300° C.

58. The process of claim 51 wherein the hydrogenation catalyst is cooled with heat exchange elements inserted in the catalyst.

59. The process of claim 51 wherein the hydrogenated gas leaving one hydrogenation catalyst bed is cooled prior to passing over the next hydrogenation catalyst bed.

60. The process of claim 51 wherein the compression of gas stream B is performed with a reciprocating compressor.

61. The process of claim 60 wherein the driver of the reciprocating compressor is an electric motor.

62. The process of claim 60 wherein the driver of the reciprocating compressor is a turbine.

63. The process of claim 51 wherein the compression of gas stream B is performed with a screw compressor.

64. The process of claim 63 wherein the driver of the screw compressor is an electric motor.

65. The process of claim 63 wherein the driver of the screw compressor is a turbine.

66. The process of claim 51 wherein the compression of gas stream B is performed with a centrifugal compressor.

67. The process of claim 66 wherein the driver of the centrifugal compressor is an electric motor.

68. The process of claim 66 wherein the driver of the centrifugal compressor is a turbine.

69. The process of claim 51 wherein the gas streams B and D are contacted with a portion of the anhydrous ammonia stream E.

70. The process of claim 51 wherein the gas streams B and D are contacted with a stream of liquid ammonia recovered after the expansion of stream E and the recompression of the liquids formed after the expansion.

71. The process of claim 51 wherein the ammonia synthesis catalyst is contained in one or more axial catalyst beds.

72. The process of claim 51 wherein the ammonia synthesis catalyst is contained in one or more axial-radial catalyst beds.

73. The process of claim 51 wherein the ammonia synthesis catalyst is contained in one or more radial catalyst beds.

74. The process of claim 51 wherein the ammonia synthesis catalyst is contained in any combination of axial, axial-radial or radial catalyst beds.

75. The process of claim 51 wherein the ammonia synthesis catalyst is contained in one or more adiabatic catalyst beds.

76. The process of claim 51 wherein the ammonia synthesis catalyst is contained in one or more catalyst beds and the reacting gas is cooled with heat exchange elements inserted in at least one of the catalyst beds.

77. The process of claim 75 wherein the reacting gas leaving one bed is cooled before entering the following bed.

78. The process of claim 77 wherein the cooling is performed with a heat exchanger.

79. The process of claim 77 wherein the cooling is performed by directly contacting the reacted gas stream leaving the bed with a colder gas stream containing any combination of hydrogen, nitrogen, ammonia and inert species.

80. The process of claim 51 wherein the reacted gas leaving the ammonia synthesis catalyst is cooled and the recovered heat is used to heat another cold stream in the process.

81. The process of claim 51 wherein the reacted gas leaving the ammonia synthesis catalyst is cooled with cooling water in a heat exchanger.

82. The process of claim 51 wherein the reacted gas leaving the ammonia synthesis catalyst is cooled with air in a heat exchanger.

83. The process of claim 80 wherein the reacted gas after the heat recovery is further cooled with cooling water in a heat exchanger.

84. The process of claim 80 wherein the reacted gas after the heat recovery is further cooled with air in a heat exchanger.

85. The process of claim 80 wherein the reacted gas after the heat recovery is first cooled with air in a heat exchanger and then cooling water in a subsequent heat exchanger.

86. The process of claim 51 wherein gas stream D is further cooled to a temperature below ambient temperature whereby generating another stream of liquid ammonia and a gas stream that contains less ammonia than gas stream D.

87. The process of claim 86 wherein the additional liquid ammonia stream is separated from the gas stream D.

88. The process of claim 51 wherein the recycling of gas stream D is performed with a single-stage compressor (circulator).

89. The process of claim 88 wherein the circulator is driven by one of the drivers used by the compressor that compresses stream B.

90. The process of claim 88 wherein the circulator is driven by a dedicated electric motor.

91. The process of claim 88 wherein the circulator is driven by a dedicated turbine.

92. The process of claim 51 wherein the recycling of gas stream D is performed by properly contacting stream B with stream D in an ejector.

93. A renewable ammonia synthesis process which comprises the following steps:
powering an electrolysis process comprising providing electricity generated by a renewable source;
generating hydrogen via the electrolysis;
compressing the hydrogen;
generating a gas stream A comprising nitrogen and oxygen wherein the majority of gas stream A comprises nitrogen;
mixing the hydrogen with gas stream A over a hydrogenation catalyst to hydrogenate at least some of the oxygenated species present in the mixed gas stream to form a new gas stream B;
compressing gas stream B;
mixing gas stream B with gas stream D below and removing water from the mixed gas stream;
running the mixed and dried gas stream over an ammonia synthesis catalyst which is capable of reacting the hydrogen and nitrogen to form ammonia in one reactor vessel or more reactor vessels in parallel or in series;
cooling the reacted gas above its dew point whereby to produce a stream C of reacted gas comprising hydrogen, nitrogen, ammonia and other minor impurities;
contacting the gas stream C with water whereby to produce an aqueous solution of ammonia and a stream of unreacted gas comprising water vapor, hydrogen, nitrogen and other minor impurities (gas stream D);
separating the resulting liquid comprising a mixture of ammonia and water from the remaining gas stream D;
separating a portion of the gas stream D to create a purge gas stream F; and
recycling gas stream D to mix it with stream B prior to removing the water.

94. The process of claim 93 wherein gas stream A is generated using a Pressure Swing Adsorption (PSA) or Vacuum Pressure Swing Adsorption (VPSA) unit.

95. The process of claim 93 wherein gas stream A is generated using membranes.

96. The process of claim 93 wherein gas stream A is generated using an Air Separation Unit (ASU).

97. The process of claim 93 wherein the hydrogenation catalyst resides in a vessel.

98. The process of claim 93 wherein the hydrogenation catalyst resides in multiple vessels in series or in parallel.

99. The process of claim 93 wherein the hydrogenation catalyst is heated to between 150° C. and 300° C.

100. The process of claim 93 wherein the hydrogenation catalyst is cooled with heat exchange elements inserted in the catalyst.

101. The process of claim 93 wherein the hydrogenated gas leaving one hydrogenation catalyst bed is cooled prior to passing over the next hydrogenation catalyst bed.

102. The process of claim 93 wherein the compression of gas stream B is performed with a reciprocating compressor.

103. The process of claim 102 wherein the driver of the reciprocating compressor is an electric motor.

104. The process of claim 102 wherein the driver of the reciprocating compressor is a turbine.

105. The process of claim 93 wherein the compression of gas stream B is performed with a screw compressor.

106. The process of claim 105 wherein the driver of the screw compressor is an electric motor.

107. The process of claim 105 wherein the driver of the screw compressor is a turbine.

108. The process of claim 93 wherein the compression of gas stream B is performed with a centrifugal compressor.

109. The process of claim 108 wherein the driver of the centrifugal compressor is an electric motor.

110. The process of claim 108 wherein the driver of the centrifugal compressor is a turbine.

111. The process of claim 93 wherein drying of gas streams B and D is performed by contacting the gas streams with a stream of liquid ammonia.

112. The process of claim 93 wherein drying of gas streams B and D is performed by contacting the gas streams with a stream of a concentrated ammonia solution.

113. The process of claim 93 wherein drying of gas streams B and D is performed by passing the streams over a bed of water sorbent material.

114. The process of claim 113 wherein the saturated sorbent material is regenerated by heating the sorbent material above a temperature of 150° C.

115. The process of claim 113 wherein the saturated sorbent material is regenerated by heating a portion or all of the purge gas stream F above a temperature of 150° C. and passing the heated stream over the saturated sorbent material.

116. The process of claim 93 wherein the ammonia synthesis catalyst is contained in one or more axial catalyst beds.

117. The process of claim 93 wherein the ammonia synthesis catalyst is contained in one or more axial-radial catalyst beds.

118. The process of claim 93 wherein the ammonia synthesis catalyst is contained in one or more radial catalyst beds.

119. The process of claim 93 wherein the ammonia synthesis catalyst is contained in any combination of axial, axial-radial or radial catalyst beds.

120. The process of claim 93 wherein the ammonia synthesis catalyst is contained in one or more adiabatic catalyst beds.

121. The process of claim 93 wherein the ammonia synthesis catalyst is contained in one or more catalyst beds and the reacting gas is cooled with heat exchange elements inserted in at least one of the catalyst beds.

122. The process of claim 120 wherein the reacting gas leaving one bed is cooled before entering the following bed.

123. The process of claim 122 wherein the cooling is performed with a heat exchanger.

124. The process of claim 122 wherein the cooling is performed by directly contacting the reacted gas stream leaving the bed with a colder gas stream containing any combination of hydrogen, nitrogen, ammonia and inert species.

125. The process of claim 93 wherein the reacted gas leaving the ammonia synthesis catalyst is cooled and the recovered heat is used to heat another cold stream in the process.

126. The process of claim 93 wherein the reacted gas leaving the ammonia synthesis catalyst is cooled with cooling water in a heat exchanger.

127. The process of claim 93 wherein the reacted gas leaving the ammonia synthesis catalyst is cooled with air in a heat exchanger.

128. The process of claim 93 wherein the reacted gas after the heat recovery is further cooled with cooling water in a heat exchanger.

129. The process of claim 93 wherein the reacted gas after the heat recovery is further cooled with air in a heat exchanger.

130. The process of claim 93 wherein the reacted gas after the heat recovery is first cooled with air in a heat exchanger and then cooling water in a subsequent heat exchanger.

131. The process of claim 93 wherein gas stream C is contacted with water over a packed bed containing material that increases the heat and mass transfer between the gas stream and water.

132. The process of claim 93 wherein packing material is contained in multiple beds arranged in series or in parallel.

133. The process of claim 93 wherein the liquid stream leaving a packed bed is cooled in a heat exchanger.

134. The process of claim 133 wherein a portion or all of the cooled liquid stream is pumped and recycled to the inlet of the packed bed.

135. The process of claim 93 wherein the liquid stream leaving a packed bed is cooled by directly contacting it with a colder liquid stream.

136. The process of claim 135 wherein a portion or all of the cooled liquid stream is pumped and recycled to the inlet of the packed bed.

137. The process of claim 93 wherein the recycling of gas stream D is performed with a single-stage compressor (circulator).

138. The process of claim 137 wherein the circulator is driven by one of the drivers used by the compressor that compresses stream B.

139. The process of claim 137 wherein the circulator is driven by a dedicated electric motor.

140. The process of claim 137 wherein the circulator is driven by a dedicated turbine.

141. The process of claim 93 wherein the recycling of gas stream D is performed by properly contacting stream B with stream D in an ejector.

142. An operating algorithm comprising the following steps is applied to control the total ammonia production rate from the process of claim 1:
the total maximum ammonia production rate is determined based on the available electric power and the maximum hydrogen production rate achievable with the power;
the hydrogen/nitrogen ratio (H/N) is computed in order to maintain the flowrate of gas stream C constant;
the flowrate of gas stream A is computed based on the H/N computed in the previous step;
the flowrate of purge gas stream F is computed based on the excess nitrogen present in stream B and compared to the stoichiometric value of 3 for H/N;
all new setpoints are set accordingly to all previous steps; and
the rotating speed and the kickback flows of the compressor of gas stream B are adjusted to maintain a constant pressure at its delivery.

143. The operating algorithm of claim 142 wherein such algorithm is applied to the process of claim 51.

144. The operating algorithm of claim 142 wherein such algorithm is applied to the process of claim 93.

145. An operating algorithm applied to the process of claim 1 comprising the following steps to control the ratio of the flowrate of liquid ammonia stream E and the total aqueous ammonia flowrate produced in the process:
the desired flowrates of anhydrous (stream E) and aqueous ammonia are computed;
the stream E flowrate target is increased by the amount corresponding to the evaporated ammonia in any subsequent adiabatic expansion;
the pressure of gas stream B delivered by a compressor is calculated in order to generate the required amount of ammonia condensation once gas stream C is cooled; and
the algorithm of claim 142 is used to compute all set points at the desired total ammonia production rate (sum of aqueous and anhydrous) while maintaining the pressure of gas stream B delivered by the compressor as computed in the previous step.

146. The operating algorithm of claim 145 wherein such algorithm is applied to the process of claim 93.
